(19) United States
(12) Patent Application Publication
(10) Pub. No.: US 2007/0091628 A1
(43) Pub. Date: Apr. 26, 2007

(54) Rimzikulz

(76) Inventor: Jason Douglas Van Order, Yukon, OK (US)

Correspondence Address: Jerry W. Anderson, 108 E. Main, Norman, OK, 73051, US

(21) Appl. No.: 11/584,966

(22) Filed: Oct. 23, 2006

Related U.S. Application Data
(60) Provisional application No. 60/729,028, filed on Oct. 22, 2005.

(51) Int. Cl. F21V 33/00

(52) U.S. Cl. 362/506

(57) ABSTRACT

A fanciful designed attachment to an automobile containing lights which illuminate tires and rims of said automobile for aesthetic reasons.

This non provisional patent application claims to U.S. Provisional Patent Application filed Oct. 20, 2005.

No federal funds were used in the development of this device

There is no microfiche appendix

### BACKGROUND OF INVENTION

This invention was conceived to address a perceived problem in the aesthetics of automobile viewing, namely the illumination of tires and rims. In recent years, automobile accessories have become an important marketing area. Automobile sound systems now feature LCD screens to show movies, sound systems has cost several thousands of dollars. With audio systems, the investment by the owner is obvious to the public, both in day and night. However, other investments are not so obvious to bystanders, especially at night. Tires and rims can now also cost several thousands of dollars, but at night these investments are not a readily apparent as the sound system. This invention utilizes a fanciful member easily attachable to the fender or wheel well of the automobile, and containing electrical connections and lights designed to illuminate the wheels and rims of the automobile. Thus allowing others to be view the aesthetically pleasing wheels and rims at night.

This invention relates to general method of illuminating for aesthetic reasons decorative accessories in the automotive field. This invention is a device supplementing the standard methods for said illumination.

There exists a need for a simple device that can be used to illuminated the aforesaid accessories. There exists no commercially available method to do so.

In addition the present invention can be easily and quickly installed by the owner of the vehicle or by a commercial accessory installer.

### DESCRIPTION OF PRIOR ART

Lights on automobiles have been in use in wide use for many years, both illumination and safety. The ability to illuminate selected areas of the automobile for aesthetic reasons would be valuable. Inventors have tried similar combinations in the past, but their devices have lacked the ability to both illuminate the desired areas, and to be an aesthetically pleasing attachment to the automobile

For instance, U.S. Pat. No. 6,871,987 B1, K. Morton, Mar. 29, 2005, describes rim illuminating device, mounted on the rim of the wheel of the automobile to create a visual effect when the automobile is moving. However in use, the device does not illuminate the entire wheel and rim, and due to its self contained power supply, the time of illumination is limited.

U.S. Pat. No. 5,548,274, K. Anderson, et al, Aug. 20, 1996, describes a rim and wheel illuminating device, mounted on the fender of the automobile. However the purpose of the illuminating device, which is a strobe light keyed to the rotation of the wheel, is to illuminate messages which are printed on the wheel, as the vehicle moves.

U.S. Pat. No. 6,945,679 R. Young, Sep. 20, 2005, describes a lighting system for safety which provides side illumination of the wheels of automobile. However the light system is not an aesthetically pleasing design, and is not designed to specifically illuminate the wheels and rims for aesthetic reasons.

U.S. Pat. Appl. Pub. No. US 2006/0158893 A1, J. Wilkerson III, Jul. 20, 2006, describes a telescoping wheel illuminating device. However, this device does not contain the aesthetically pleasing appearance of the device herein.

U.S. Pat. No. 6,030,196, J. L. Johnson, Feb. 29, 2000. Describes a light display device, wherein the lights are mounted on the rim of the automobile and rotate with the wheel. However this device is more a light display, than a device to provide illumination for the tire and wheel.

U.S. Pat. Appl. Pub. No US 2004/0130905, R. Olds, et al, Jul. 8, 2004, describes a stroboscopic light system designed to illuminate messages on indica on the wheel or rim. However this is not similar to the present system which is designed to illuminate the entire wheel and rim.

U.S. Pat. No. 4,881,153, R. Scott, Nov. 14, 1989, describes a vehicle wheel lighting system, wherein the light is attached to the rim, and rotates with the wheel. Rotating contacts allow power to be communicated from the automobile to the light. However this device is a light display, rather than a device to provide illumination for the tire and wheel.

U.S. Pat. No. 4,430,692 A. Papadakis, Feb. 7, 1984, is a automotive wheel illumination system consisting of a light source, fiber optics communicating light to the center of the rim, and reflective surfaces on the rims. This device is designed to provide a light display, rather that provide illumination for the tire and wheel.

U.S. Pat. No. 6,601,979 R. Byrd, Aug. 5, 2003, describes a wheel illumination device consisting of light emitting diodes mounted on the rim, with a contacts providing power from the automobile. This is, again, a light display mounted on the rim and rotating with the tire, not a system to illuminate the tire and wheel.

U.S. Pat. No. 5,392,200, M. Milde, Feb. 21, 1995, describes another lighting display that rotates with the rim, and does not provide illumination of the tire and rim.

U.S. Pat. No. 6,116,762, I. Kutlucinar, describes a lighting display mounted in a hubcap, with internal lights and power supply, which rotates with the rim, and does not provide illumination of the tire and rim.

U.S. Pat. No. 6,164,792, M. Nakogomo, describes a system for controlling a illuminating light for an automobile, said light may illuminate the instrument panel, said control may cause to pulsate in time with either voice commands or music. However the device is a controller for a lighting system, not a lighting system as described in the present device.

None of the previously described devices have been used to as a solely aesthetic attachment to the automobile and to illuminate in a aesthetically pleasing manner the wheels and rims of the vehicle. The present invention greatly enhances the appearance of the automobile, being both aesthetic design and illuminating rims and wheels of the automobile.

### DISCRIPTION OF INVENTION

The described device is an attachment that can be mounted on the fender of an automobile as a decorative element and to illuminate the wheel and wheel rims of the automobile. The device is attached to the vehicle by bolting it to the inside or bottom of the fender above the wheel. The device contains a series of lights to illuminate the wheels and wheel rims of the automobile. The device, in the preferred embodiment, is plastic, but can be made of other materials, such as metal, and/or other types of plastic, fiberglass, etc. The lights can be controlled from the cab of the vehicle, and can be switched off and on singly or together, or can be controlled to the beat of music being played in the car.

The control can be either a switch on the dash, a remote control so that the lights can be turned on from outside the automobile, or can be wired such that, as mentioned before, the lights can pulse in rhythm with the music. Lights in the device are, at present, standard small incandescent bulbs, and are normally white light, but can be other colors and could be florescent, depending on state regulations concerning same.

Device is a fanciful design, resembling flames, colored in a flame pattern with a background normally purple. Colors and design may change.

Name of device, Rimzikulz, is printed on center of device, so that it can be seen from the outside of the car.

The preferred embodiment is as shown in the attached drawings.

### BRIEF DESCRIPTION OF DRAWINGS

FIG. 1 shows the device attached to the automobile. The device is shown attached to only one fender for purposes of illustration. The device, in the preferred embodiment will be attached to all four fenders.

FIG. 2. shows the current fanciful design. This design can be changed, depending on desires of the customer.

FIG. 3. shows the arrangement wiring and lights for the device.

FIG. 4. shows the method of attachment of the device to the automobile to the fender of the automobile with the electrical wiring going into the device.

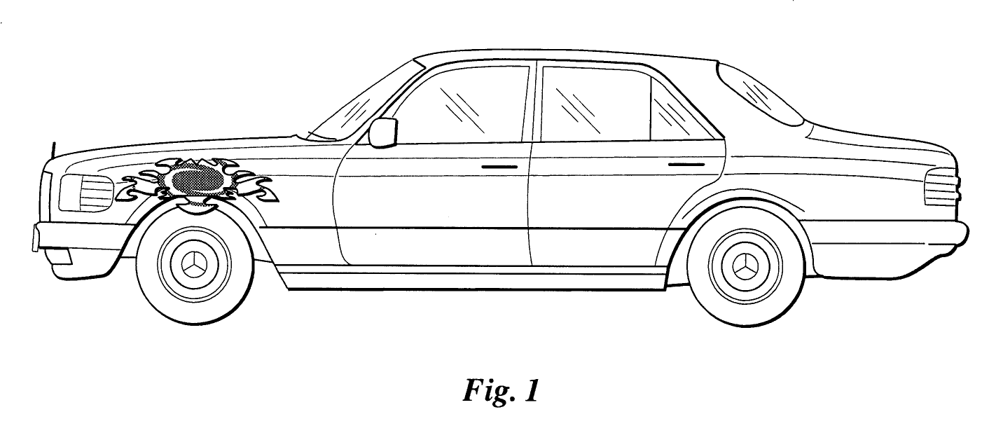

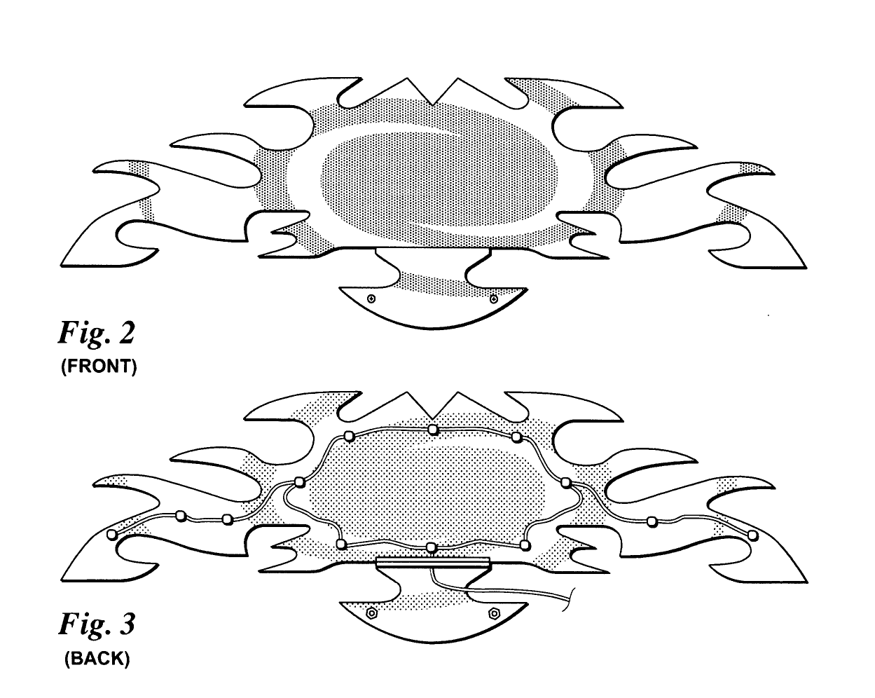

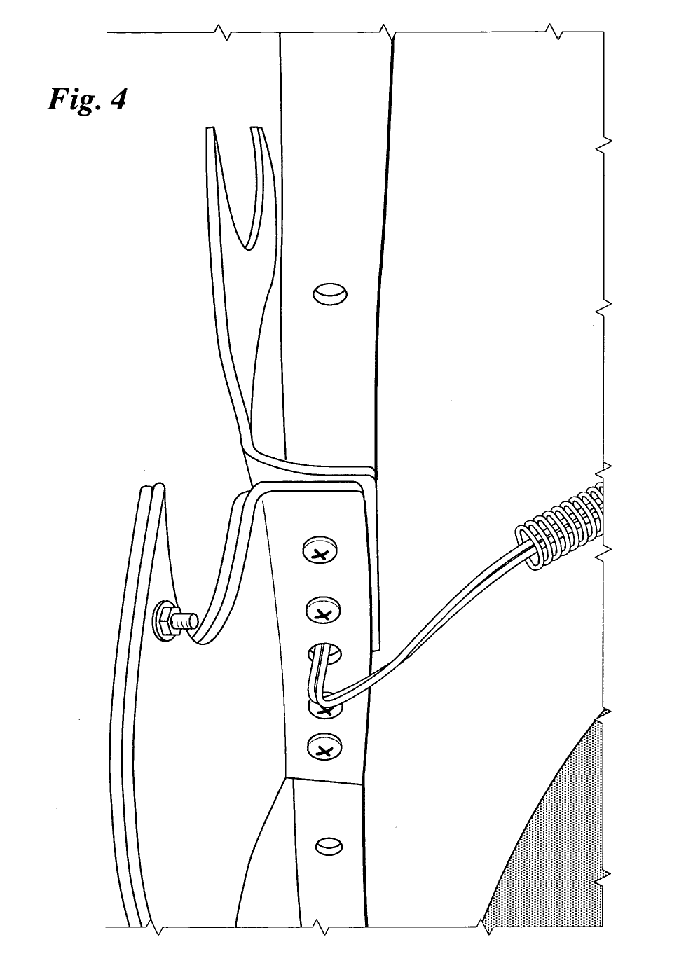

1. What is claimed is a attachment to be mounted on the fender of an automobile to illuminate the wheel and wheel rims of the automobile.

2. The attachment in claim 1, wherein the mechanism to illuminate said wheel and wheel rim comprises a series of lights.

3. The attachment in claim 1, where in the body of the attachment made be made of one of the following materials: plastic, fiberglass, aluminum or steel.

4. The attachment in claim 1, wherein the illumination may be switched on or off by a control in the passenger compartment of the automobile.

5. The attachment in claim 1, wherein the illumination may be controlled by a remote control switch.
